(19) United States
(12) Patent Application Publication
(10) Pub. No.: US 2015/0360329 A1
(43) Pub. Date: Dec. 17, 2015

(54) CRACK REPAIR METHOD FOR TURBINE COMPONENTS USING SPARK PLASMA SINTERING

(71) Applicant: SIEMENS AKTIENGESELLSCHAFT, München (DE)

(72) Inventors: Gia Khanh PHAM, Neubiberg (DE); Sebastian PIEGERT, Lübbenau (DE); Grady L. SMITH, Charlotte, NC (US)

(21) Appl. No.: 14/303,729

(22) Filed: Jun. 13, 2014

(51) Int. Cl. B23P 6/04; B22F 3/12; B22F 5/04; B22F 7/04; B22F 5/00; B23P 6/00; B22F 3/105

(52) U.S. Cl. CPC B23P 6/045; B23P 6/007; B22F 3/12; B22F 3/105; B22F 7/04; B22F 5/009; B22F 5/04

(57) ABSTRACT

A crack repair method for a turbine component using spark plasma sintering: Applying filler material on a cracked portion of the turbine component. Applying joining pressure on the cracked portion of the turbine component by punches pressing on the component. Simultaneously heating the filler material by an application of electric current. Then cooling the heated filler material to form a joint at the cracked portion.

### FIELD OF INVENTION

The present invention relates to a crack repair method for turbine components, and more particularly to a repair method for turbine components using spark plasma sintering.

### BACKGROUND OF THE INVENTION

Turbine components that are subjected to loading, such as turbine blades for instance, undergo high thermal and mechanical stress during operation, possibly leading to instances of material fatigue and as a consequence to cracks. Since the production of components which are exposed to heavy loading during operation, for example components of a gas turbine, is relatively costly, it is generally endeavored to repair such components when they are damaged. This makes the component serviceable again and allows it to be used for a further period between inspections.

Typically, cracks in turbine components, especially ones made from super alloys (e.g., low grade Ni-based alloys), are repaired using a brazing technique. In the brazing technique, a filler material, such as a mixture of metal powders with an organic/in-organic binder, is introduced in a crack to be repaired and is subsequently heated to its melting point in a vacuum so as to form a bond between the base material of the turbine component and the filler material.

It is important that repair of the turbine components be effectively carried out such that the repaired turbine components have properties as close as possible to those of original turbine components. However, in a brazing technique, long heat treatment cycles (up to several hours) results in formation of brittle phases and massive grain growth in the repaired turbine component, thereby leading to reduced mechanical integrity of the repaired turbine component.

In light of the foregoing, there is a need for a crack repair method which yields a repaired turbine component having properties as close as possible to the original turbine component in a minimal time period.

### SUMMARY OF THE INVENTION

A crack repair method for turbine components using spark plasma sintering is disclosed. In one aspect method of repairing a turbine component, particularly a gas turbine component, using spark plasma sintering (SPS) comprises the step of applying filler material on the cracked portion of the turbine component. For example, the filler material comprises a mixture of super alloy powder, braze material and a binder. The turbine component is made of low grade Ni-based alloys or steel material.

The method further comprises the steps of applying a joining pressure on the cracked portion of the turbine component, and simultaneously heating the filler material by application of electric current. This leads to melting and sintering of the particles in the filler material and formation of ‘necks’ around the area of contact between the particles and also the interface of the cracked portion. Additionally, the method comprises cooling the heated filler material to form a joint at the cracked portion of the turbine component. Thus, the crack in the turbine component is repaired using single operation of the spark plasma sintering (SPS) process. Advantageously, time required to repair the turbine component is significantly reduced. Also, using the SPS process, desired temperatures in the range of 1000 to 2000 degree centigrade can be reached in a very short time. Due to this, brittle phases are not formed and grain growth is suppressed, thereby obtaining a high quality joint at the cracked portion.

For applying the joining pressure, the method comprises the steps of positioning the turbine component between a pair of punches, and applying the joining pressure on the cracked portion of the turbine component via the pair of punches.

For simultaneously heating the filler material, the method comprises the step of applying electric current to the pair of punches till the filler material is heated to a desired temperature.

The filler material is heated in a vacuum or an inert gas environment. Thus, oxidation of the turbine component during the SPS process is prevented.

The filler material is heated using hybrid heating process. Thus, the filler material is heated in a short time.

The above-mentioned and other features of the invention will now be addressed with reference to the accompanying drawings of the present invention. The illustrated embodiments are intended to illustrate, but not limit the invention.

### BRIEF DESCRIPTION OF THE DRAWINGS

The present invention is further described hereinafter with reference to illustrated embodiments shown in the accompanying drawings, in which:

FIG. 1 illustrates a schematic representation of a Spark Plasma Sintering (SPS) machine used in repairing a turbine component according to an embodiment of the present invention; and

FIG. 2 is a flowchart illustrating an exemplary process of repairing a turbine component according an embodiment of the present invention.

### DETAILED DESCRIPTION OF THE INVENTION

Various embodiments are described with reference to the drawings, wherein like reference numerals are used to refer the drawings, wherein like reference numerals are used to refer to like elements throughout. In the following description, for the purpose of explanation, numerous specific details are set forth in order to provide thorough understanding of one or more embodiments. It may be evident that such embodiments may be practiced without these specific details.

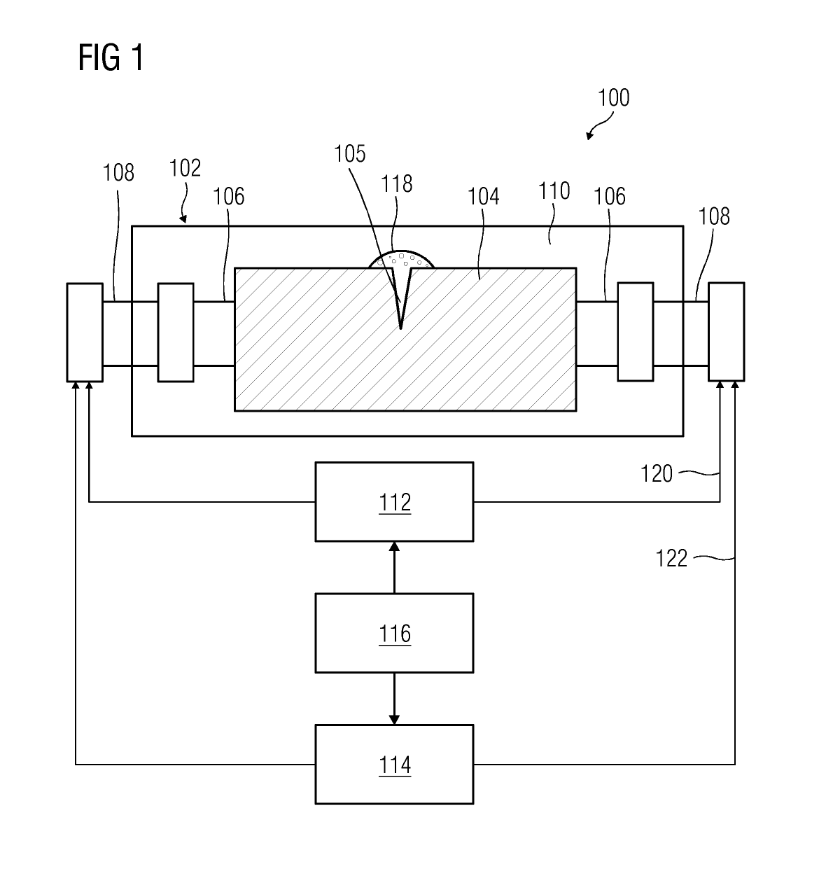

FIG. 1 illustrates a schematic representation 100 of a Spark Plasma Sintering (SPS) machine 102 used in repairing a turbine component 104 according to an embodiment of the present invention. The SPS machine 102 comprises a pair of punches 106, electrodes 108 connected to each one of the pair of punches, a chamber 110 which houses the electrodes 108 and the pair of punches 110, a heating system 112, a press 114, and a control unit 116.

The present invention uses the SPS machine 102 to repair the crack in the turbine component 104, especially a gas turbine component, using a spark plasma sintering (SPS) process (also known as field assisted sintering technique (FAST)). To repair the turbine component 104, the turbine component 104 is placed between the pair of punches 106, which are particularly made of graphite, in the chamber 110 such that joining pressure can be applied on the cracked portion 105. Thereafter, filler material 118 is applied on the surface of the cracked portion 105.

The filler material 118 comprises a mixture of super alloy powder, braze material, and organic or inorganic binder. The filler material 118 is selected to be compatible with the metal forming the turbine component 104. The physical properties of the filler material 118 are based on its metallurgical composition. The metallurgical composition determines whether the filler material 118 is compatible with the turbine component 104, i.e., capable of repairing the crack without forming detrimental metallurgical compounds. The filler material 118 is selected such that melting point of the filler material 118 is much lower than the melting point of the turbine component 104.

After applying the filler material 118, the press 114 applies a joining pressure (P) 120 on the cracked portion 105 of the turbine component 104 in an axial direction by compressing the punches 106 toward each other in the direction of the turbine component 104. For example, the punches 106 can be operated using hydraulic pressure or pneumatic pressure. Simultaneously, the heating system 112 applies electric current (I) 122 to the turbine component 104 via the electrodes 108 connected to the punches 106 to heat the cracked portion 105 and the filler material 118. Due to application of the electric current to the punches 106, the pair of punches 106 in heated quickly. The pair of punches 106 in turn heats the cracked portion of the turbine component 104 and the filler material 118 by way of thermal conduction. This leads to melting and sintering of particles in the filler material 118 and formation of ‘necks’ around the area of contact between the particles and also the interface of the cracked portion 105. Thus, using the SPS process, the cracked portion 105 and the filler material 118 are heated in a short time (e.g., within 0.5 to 1 hour). The filler material 118 is heated under a vacuum environment. Alternatively, the filler material 118 is heated in an inert gas environment. The chamber 110 may be connected to vacuum or to a gas supply to maintain a vacuum or inert gas environment during heating of the filler material 118. The vacuum or inert gas environment prevents oxidation of the turbine component during the repair process.

The heating system 112 applies a pulsed direct current or continuous direct current to the electrodes for heating the filler material 118. One can envision that, hybrid heating techniques can also be used to facilitate faster and efficient heating of the cracked portion 105 and the filler material 118.

The heating system 112 gradually reduces the electric current applied to the turbine component 104. As a result, the pair of punches begins to cool and hence the interfaces of the cracked portion 105 and the heated filler material 118 cool. Upon cooling, a joint is formed between the filler material 118 and the interfaces of the cracked portion 105 in a single operation by a SPS process in a short time without need to use a supplementary heat treatment. In this manner, a crack in the turbine component 104 is repaired. The above described repair process can be best suited for turbine components made from super alloys, preferably low grade Ni-based alloy such as Hastealloy X, IN 625 and IN 718, and steels such as 16Mo3, X6CrNiTi18-10. One skilled in the art will understand that the above described repair process may also be used for repairing cracks in turbine components made from other materials. One can envision that the above process can also be used for repairing cracks in any metal components.

It can be noted that the amount of the electric current 122 and the pressure 120 applied are automatically controlled by the control unit 114. Thus, the control unit 114 assists in operating the press 116 and the heating system 112 during the repair process.

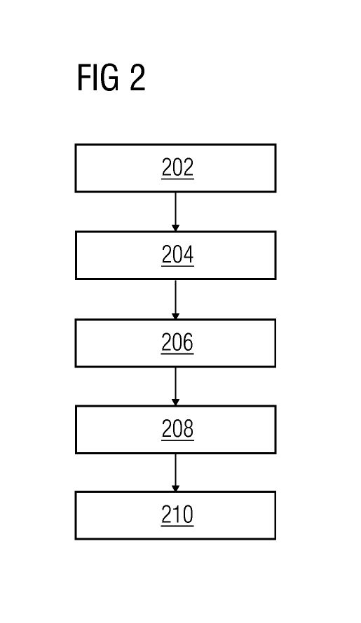

FIG. 2 is a flowchart 200 illustrating an exemplary process of repairing a turbine component according to an embodiment of the present invention. At step 202, a turbine component with a cracked portion is placed in the chamber 110 of the SPS machine 100 which is under vacuum or filled with inert gas. The turbine component is loaded between the pair of punches 106, which are especially made from graphite material. At step 204, filler material is overlaid on a surface of the cracked portion. At step 206, a joining pressure is applied on the cracked portion of the turbine component in an axial direction using the punches 106.

At step 208, the cracked portion of the turbine component and the filler material are heated by applying electric current to the pair of punches 106. In one embodiment, the cracked portion of the turbine component and the filler material are heated using a SPS process. In another embodiment, the cracked portion and the filler material are heated using a hybrid heating process. Hybrid heating is a combination of SPS process and an additional heating method, such as a radiation heating process. For example, the heating at step 208 takes place at the rate of 10 to 200 K/min. It can be noted that, the rate of heating depends on the type and the quantity of the filler material applied on the cracked portion.

The electric current is applied to the pair of punches 106 until a desired temperature of the filler material is attained. In an exemplary implementation, the electric current is applied to the pair of punches 106 via the electrodes 108. The electric current is applied to the pair of punches 106 to heat the pair of punches 106 and eventually heats the cracked portion of the turbine component and the filler material applied therein. This results in melting and sintering of the particles in the filler material 118 and formation of necks around the area of contact between the particles and also the interface of the cracked portion 105.

At step 210, the filler material and the cracked portion are allowed to cool by reducing the electric current applied on the pair of punches 106. For example, the repaired cracked portion is cooled at a rate of 10 to 200 K/min. As molten filler material is cooled, a joint is formed at the cracked portion of the turbine component. Accordingly, the joining pressure is then released. Following the SPS process, the surface of the turbine component is preferably machined to original dimensions as specified for the turbine component. In this manner, the crack in the turbine component is repaired using the spark plasma sintering process. Unlike a conventional brazing process, turbine components can be repaired using the SPS process in 1 to 2 hours. Also, using the above SPS process, desired temperatures in the range of 1000 to 2000 degree centigrade can be reached in very short time. Thus, by the above process, formation of brittle phases and massive grain growth due to the process are avoided due to short heat treatment cycles (in the range of 30 minutes to 1 hour). Advantageously, mechanical integrity of repaired turbine components is not affected. The repair process makes it possible to produce significant time and energy savings.

While the present invention has been described in detail with reference to certain embodiments, it should be appreciated that the present invention is not limited to those embodiments. In view of the present disclosure, many modifications and variations would be present themselves, to those skilled in the art without departing from the scope of the various embodiments of the present invention, as described herein. The scope of the present invention is, therefore, indicated by the following claims rather than by the foregoing description. All changes, modifications, and variations coming within the meaning and range of equivalency of the claims are to be considered within their scope.

What is claimed is:

1. A method of repairing a turbine component using spark plasma sintering, comprising the steps of:
applying a filler material on a cracked portion of the turbine component;
applying a joining pressure on the cracked portion of the turbine component;
while applying the pressure, simultaneously heating the filler material by application of electric current for heating the component; and
cooling the heated filler material to form a joint at the cracked portion of the turbine component.

2. The method according to claim 1, wherein the applying of the joining pressure on the cracked portion of the turbine component comprises:
positioning the turbine component between a pair of punches;
applying the joining pressure on the cracked portion of the turbine component via the pair of punches.

3. The method according to claim 2, wherein simultaneously heating the filler material comprises:
applying the electric current to the pair of punches to heat the filler material.

4. The method according to claim 1, further comprising the heating of the filler material using pulsed direct current.

5. The method according to claim 1, further comprising the heating of the filler material using continuous direct current.

6. The method according to claim 1, further comprising the filler material comprises a mixture of super alloy powder, braze material and a binder.

7. The method according to claim 1, further comprising the turbine component is made from low grade Ni-based alloys.

8. The method according to claim 1, further comprising the turbine component is made from steel material.

9. The method according to claim 1, further comprising the heating of the filler material in a vacuum environment.

10. The method according to claim 1, further comprising the heating of the filler material in an inert gas environment.

11. The method according to claim 1, further comprising the heating of the filler material is by using a hybrid heating process.
